(19) United States
(12) Patent Application Publication
(10) Pub. No.: US 2003/0195833 A1
(43) Pub. Date: Oct. 16, 2003

(54) System and method for improved information exchange in trade shows

(76) Inventor: Robert Baranowski, San Diego, CA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/124,175

(22) Filed: Apr. 16, 2002

(51) Int. Cl. G06F 17/60

(52) U.S. Cl. 705/37; 342/191

(57) ABSTRACT

Attendance at a trade show can be made more efficient by providing a website that can be accessed prior to attending the show. Through the website, a schedule of exhibitors or events can be created, preferably based on user criteria defining exhibitors, products or services desired. This schedule can be kept and dynamically altered on a portable device with wireless communications capability that communicates with a wireless infrastructure providing a service area at said trade show. The wireless infrastructure can also be used for communication among trade show attendees, receipt of e-mail, information gathering, making purchases, etc.

### RELATED APPLICATIONS

The present application is a continuation-in-part of prior U.S. patent application Ser. No. 09/525,340, filed Mar. 14, 2000 and entitled “System and Method for Enhancing User Experience in a Wide-Area Facility Having a Distributed, Bounded Environment.”

### FIELD OF THE INVENTION

The present invention relates to the field of conducting trade shows and conventions. The present invention also relates to the field of wireless systems for transmitting data electronically. More specifically, the present invention relates to the use of a wireless system to enhance the information exchange that takes place in a trade show environment.

### BACKGROUND OF THE INVENTION

Trade shows exist for two main reasons: information exchange and networking. Businesses and customers expend large amounts of money annually to participate in and attend trade shows to exchange information on products and services and to meet potential and existing partners face-to-face.

The information exchanged at trade shows is usually between businesses and potential customers. Traditionally, businesses with products or services to sell are the exhibitors at trade shows, and customers of these products and services are the attendees of the show. The intent is to create an environment where potential customers can evaluate products and services for purchase, while meeting with representatives of the companies that provide those products or services. If the information exchange and contact networking is done right, the attendee will have enough information to make an informed purchase. Purchases sometimes happen at the trade show, but more often larger purchases are made sometime after the show based upon information received and contacts made at the trade show.

With business people having less and less available time on their hands, it becomes more important for trade show attendees to accomplish their goals of attendance in a shorter amount of time. However, as businesses expand, there may also be more and more potential partners at a trade show with which an attendee would like to make contact.

Despite these pressures, the trade show industry has made few changes over the years in its modes of operation. There have been attempts at creating ‘virtual trade shows’ that perform the same functions as the conventional trade shows. However, while these virtual trade shows may satisfy the information exchange function of such events, they fail to address the face-to-face contact and networking function that keeps people coming to the old-fashioned trade shows year after year.

Other efforts to increase the value of a trade show to an attendee focus on particular aspects of the setup for the show in an effort to make the overall experience more efficient. These improvements include electronic registration systems, trade show floor previews on the Internet, search functions to help find a product or service before attending the trade show, and contact information exchange systems. These improvements help in planning attendance at a trade show and making the exchange of contact information simpler, but do not significantly improve the efficiency of an attendee walking the trade show floor.

A comprehensive system for improving the efficiency of attendance at a trade show is needed. This improved efficiency will reduce the amount of time needed by an attendee for attendance preparation, show attendance, collected information organization, and follow-up, and will lead to a purchase decision in a shorter amount of time.

### SUMMARY OF THE INVENTION

The present invention provides, among other things, a method for attending a trade show at a trade show venue including carrying a wireless portable device with a user interface while attending the trade show, and, with the portable device, receiving information about the trade show from a wireless infrastructure that provides a wireless service area encompassing some or all of the trade show venue. This method may also include additional steps such as: displaying a map of the trade show on the portable device; displaying a current location of the portable device on the map; displaying a current location of one or more other trade show attendees on the map; receiving a message with the portable device; and sending a message with the portable device. The portable device may also be used to conduct a two-way voice communication with another trade show attendee who is also using a portable device.

The method may also include tracking a schedule of exhibitors, seminars, meetings, events, presentations, etc. to be visited at the trade show with the portable device. Such a schedule may be created by logging onto a trade show website prior to attending the trade show to generate the schedule of exhibitors. Alternatively, the schedule may be created by entering basic criteria into the portable device. Generating the schedule may include entering criteria to the website defining products, services or exhibitors of interest to a user; and generating the schedule based on the criteria.

The method may further include, with the portable device, storing collected information about products, services or exhibitors at the trade show. The storing of collected information may include directing the information to a web account of a user that is accessible via the Internet and accessing the web account via the Internet to access the information.

The method may also include making a purchase by entering a purchase order into the portable device. The method may also include providing contact information to an exhibitor at the trade show by electronically downloading the contact information from the portable device to a data exchange box associated with the exhibitor. The method may also include receiving advertisements with the portable device. These advertisements may be delivered to individual attendees based upon some criteria, possibly including preferences, schedule, location, etc. The wireless infrastructure may be connected to the Internet, and the method may then include receiving an e-mail message transmitted via the Internet with the portable device.

The present invention also encompasses trade show venue that includes: spaces for exhibitors within the trade show venue; a network of wireless base stations that provide a wireless communication service area within the trade show venue; and a controller configured to communicate with the network of wireless base stations to provide data to wireless portable devices in the service area used by trade show attendees.

The present invention also encompasses a method of conducting a trade show at a trade show venue by providing attendees with a wireless portable device with a user interface to be carried while attending the trade show; and transmitting receiving information about the trade show to the portable devices from a wireless infrastructure that provides a wireless service area encompassing some or all of the trade show venue.

The present invention also encompasses a method of soliciting attendance at a trade show by providing a website with information about the trade show; receiving criteria through the website that defines a product, service or exhibitor that a prospective attendee of the trade show desires; and generating a schedule for attending the trade show for the prospective attendee based on the criteria. This method may further include accepting registration for the trade show through the website.

This method may also include downloading the schedule into a personal digital assistant for use at the trade show or printing the schedule for use at the trade show. Once the schedule is in the personal digital assistant, the attendee can make changes to the schedule, or the current location of the attendee can be used to automatically adjust the schedule. At least one kiosk may be provided at the trade show at which an attendee can update or make changes to the schedule, or transmit contact information to a designated exhibitor or receive and store information from a particular exhibitor.

This method may also include an attendee using the wireless portable device to access information on the area businesses including hotels, restaurants, stores, rental car locations, etc. The attendee can find additional information about these businesses, optionally making reservations or purchases using the portable device while still within the trade show venue. Additionally, the attendee may use the portable device to make travel arrangements or take advantage of partnership arrangements that have been established between the trade show venue and certain service providers.

### BRIEF DESCRIPTION OF THE DRAWINGS

The accompanying drawings illustrate preferred embodiments of the present invention and are a part of the specification. Together with the following description, the drawings demonstrate and explain the principles of the present invention.

FIG. 1 is a block diagram of a preferred embodiment of the present invention.

FIG. 2 is a block diagram of a portable device according to the principles of the present invention.

FIG. 3 is a block diagram of a wireless base unit according to the principles of the present invention.

FIG. 4 is a flowchart of an attendee's visit strategy, before, during, and after the trade show according to the principles of the present invention.

Throughout the drawings, identical elements are designated by identical reference numbers.

### DETAILED DESCRIPTION OF THE PREFERRED EMBODIMENTS

The present invention includes an embodiment in which a wireless infrastructure provides data to portable wireless units used by trade show attendees. The wireless units receive data from the supporting infrastructure that allows the attendee to maximize the efficient use of his or her time at the trade show. Using the drawings, the preferred embodiments of the present invention will now be explained.

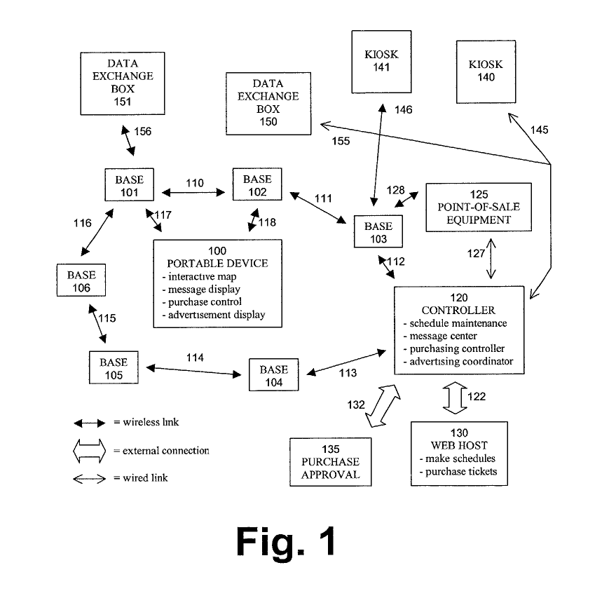

FIG. 1 illustrates a preferred embodiment of the present invention. FIG. 1 illustrates a trade show environment in which a wireless infrastructure supports the use of portable wireless units used by attendees of the show. The system illustrated in FIG. 1 can be scaled up or down to accommodate the size of the trade show.

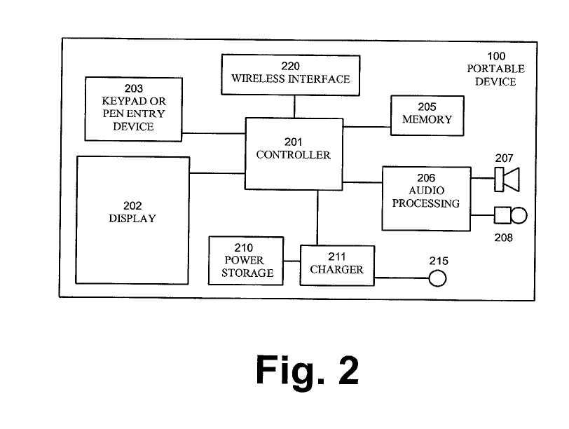

The primary interaction that an attendee has with the system is through the portable device (100). The portable device (100) is illustrated in further detail in FIG. 2 and will be further discussed below. For example, the portable device (100) may be a Personal Digital Assistant (PDA) or the like, with the ability to communicate wirelessly with a supporting infrastructure (101-106).

The portable device (100) receives data from, and transmits data to, the supporting wireless infrastructure (101-106). This communication allows an attendee to maximize the efficient use of his or her time while at the trade show. For example, with the portable device (100), the show attendee can view any or all of the following: his or her own location on a map of the trade show, an itinerary of exhibitors, seminars, events, etc. the attendee plans to visit, the location of the next exhibitor on the itinerary, a scheduled time to visit the next exhibitor or any subsequent exhibitor on the itinerary, etc.

The portable device (100) can also be used to transmit and receive messages. The messages are transmitted through the wireless infrastructure (101-106) and to or from the various portable devices (100) interacting with the infrastructure. In this way, one attendee at a trade show using a portable device can communicate with a second attendee at the show using a second portable device. Messages, either audio or visual, being in the form of text, graphic, audio or video, can be sent and received with the portable device (100).

Additionally, the portable device (100) can be used to communicate with exhibitors, vendors or the show organizers to purchase goods and services. An order for goods or services can be transmitted to the appropriate trade show participant using a portable device. Advertisements can also be broadcast to trade show attendees via the portable device (100). A purchase may be made in response to a particular offer embodied in an advertisement.

The wireless infrastructure that portable device (100) interacts with is made up of a controller (120) and a number of base stations or bases (101-106) distributed throughout the trade show environment. Communication between the portable device (100), controller (120), and the bases (101-106) is preferably wireless. In FIG. 1, arrows (110-118) illustrate wireless data links among the various bases (101-106), the controller (120) and the portable device (100).

Preferably, the wireless links (110-118) are implemented with radio frequency communications that are popular and inexpensive to implement. For example, many manufacturers have been designing components for the ISM band. Competition in these parts has pushed the technology and driven down costs to make these components very attractive for applications such as the present invention.

However, within the principles of the present invention, the data links (110-116) between base stations (101-106) and the data links (112, 113) between the bases (101-106) and the controller (120) can be wired links. The wired links would preferably be an Ethernet network. In this wired network, each base may be wired to a central location near the controller (120), or may be configured with a series of networking hubs distributed throughout the trade show venue. Wired links can carry the requisite data within the infrastructure, but may be more difficult to conveniently provide in an environment not built to provide for such wiring.

Data received by the bases (101-106) from a portable device (100) are wirelessly sent to the controller (120) via data links (112 or 113). The data could be, for example, a request for information, a text or voice message, a purchase order, etc. If data is received, for example, by base (101), the data may be relayed to base (102) through wireless link (110), then relayed to base (103) through wireless link (111), then relayed to the controller (120).

A mesh network topology in which messages are passed from node to node and propagate across the physical network space based upon the location of each base is preferred in this embodiment. A different scheme can be employed, such as a point-to-point configuration, where each base transmits its messages to the assigned next base in the chain, retrying until acknowledged. Or, network hubs can be distributed throughout the coverage area, collecting messages and sending them directly to the host. These methods may apply to either the wireless or wired base connection embodiments.

Controller (120) is similar in architecture to the portable device (100), but is a high-power fixed system. Controller (120) runs the software that maintains the schedules of all attendees within range of the system, maintains the schedules of all seminars or exhibitions or other events of the trade show, maintains the current locations of all attendees, serves as the message center for all messages, controls and verifies all purchases made by portable devices, controls all of the advertising seen by the attendees, and manages the information stored by attendees.

Controller (120) may connect to a purchasing system including point-of-sale equipment (125) through a wired link (127). The point-of-sale equipment may be, for example, a computerized cash register or inventory system. Wired link (127) is preferably a part of an Ethernet network.

Alternatively, the connection between the controller (120) and the point-of-sale equipment (125) can also be through a wireless connection, e.g. wireless link (112), through base (103), and then through wireless connection (128). The interaction between the point-of-sale equipment (125) and the controller (120) includes purchase items, purchase totals, and approvals or declines of purchases. The controller (120) may also access nationwide credit card approval sites (135) over, for example, a wired connection (132) when credit approval for a purchase is required.

When a purchase order is received, the transaction data includes identification information for the attendee making the purchase and pertinent purchase information. The controller (120) may receive the purchase order and complete the sale by interacting with the point-of-sale equipment (125) as described above. Alternatively, the portable device (100) may interact directly with the point-of-sale equipment (125). This may be accomplished, for example, through wireless link (128).

Schedules and attendee information, including contact and product preferences, can be entered from outside the wireless network through, for example, a web site on the Internet. The web site is supported by a hosting server (130) which is in communication with the controller (120). The hosting server (130) can be at a separate location from the trade show and mirrored, via an Internet connection, to the controller (120). Or the hosting server (130) can be at the trade show location and directly connected to the controller (120).

Through the web host (130), customers can enter contact and product preferences as well as desired schedules or itineraries that they wish to follow while at the trade show. This information is then transmitted to and used by the controller (120). The show attendee can access the web host (130) and plan his or her attendance at the show long before actually attending the show.

While at the show, attendees can also collect information from exhibitors and enter that information into the portable device (100) for storage. Electronic brochures may also be prepared by exhibitors and transmitted to the account of an attendee on the controller (120) at the attendee's request. Attendees can then review the information collected while at the trade show by accessing an account on the web host (130). The information may either be stored on web hosting machine (130) or at an alternative high capacity storage location in communication with the web host (130).

Kiosks (e.g., 140 and 141) provide services to attendees that have accounts set up on the system controller (120), but do not have a portable device (100) or have a portable device that lacks wireless communication capability. The kiosks (140, 141) allow the attendees to access their account, check email, modify schedules, review collected information, etc. The kiosks (140, 141) can connect to the system controller (120) using either in a wired network link (145), or a wireless link such as link (146) to base (103) and then link (112) to controller (120). The results of the visit to the kiosk (140, 141) can be downloaded into a portable device that lacks wireless communication capability by, for example, an infrared transceiver or a wired connection. Alternatively, the results of the visit to the kiosk can be printed in hard copy form for use by the attendee.

In some trade show implementations, each exhibitor's booth could have a device for collecting contact information and enabling information transfer. In the past, trade show attendees have been able to carry a credit-card sized card with a magnetic stripe on the back. The contact information of that attendee is encoded in the magnetic strip on the back of the card. When the attendee wants additional information from a particular exhibitor, that attendee can swipe his or her card through a magnetic card reader at exhibitor's booth from which additional information is desired. In this way, the attendee's contact information is transferred to the exhibitor who can then follow up with more information for that attendee.

Under the principles of the present invention, data exchange boxes (e.g., 150 and 151) can serve a similar purpose. The data exchange boxes (150, 151) may communicate with an attendee's portable device (100). For example, the data exchange box (150, 151) may have a data cable that can be connected to a corresponding port on a portable device. Alternatively, the portable device (100) and the data exchange box (150, 151) may each have an infrared transceiver so that data can be exchanged between the two wirelessly.

An attendee can upload his or her contact information to a designated exhibitor through a data exchange box (151, 150) or direct that his or her contact information be provided to the designated exhibitor through the data exchange box (150, 151). The exhibitor can then contact and provide additional information to that attendee at a later time. The data exchange box (151, 150) can also be used to track attendance at seminars, events, or other functions within the trade show venue.

Additionally, product information appropriate for an attendee's level of interest can be downloaded from a data exchange box (150, 151) to the attendee's portable device (100). Alternatively, the attendee can use the portable device (100) and data exchange box (150, 151) to direct product or exhibitor information to his or her account on the web host (130) for later retrieval as mentioned above.

The data exchange boxes (150, 151) can be wired or wirelessly connected back to the controller (120). For example, the data exchange box (150) is wired back to the controller (120) through wired connection (155). The data exchange box (151) has a wireless connection (156) back to the controller (120), via base (101) and the intervening bases (102, 103) with wireless data links (110-112).

As noted above, one function performed by the portable device (100) is to identify where an attendee is and display that location on a map of the trade show to assist the attendee in navigating through the show. There are several means within the scope of the present invention that allow the portable device (100) to be aware of its location relative to a map of the trade show. These means will now be described.

In the exemplary embodiment of FIG. 1, the portable device (100) has an established communication link with two of the bases (101 and 102) using communication links (117 and 118), respectively. From the identification numbers of the bases (101, 102), the portable device (100) and the controller (120) know the approximate location of the device within the coverage area. The portable device (100) can use this location for its interactive mapping functions. The controller (120) can use the location as it interfaces with the scheduling software and some of its other functions.

Location of portable device (100) can also be determined by other means than the identification numbers of the bases that are within range of the portable device (100). For example, in other embodiments, the location of portable device (100) can be determined by GPS, cellular E911, or other location technology that may be in existence at the time of embodiment.

The system of the present invention can also provide a dynamic schedule or itinerary for attendees of the trade show. For example, as mentioned above, an attendee can access the trade show web site at the web host (130). The attendee may do this before or after arriving at the trade show. The attendee can then build a schedule of exhibitors and events to attend at the show. Each attendee using the system can separately define his or her own schedule. The schedule can be defined by having an attendee specify each exhibitor and event of interest. Additionally, the schedule can be defined by having the attendee answer some questions to prioritize the schedule. Based on answers to general questions, the system can recommend particular exhibitors or seminars that the attendee might be interested in.

Once the schedule is created, it is transmitted to the controller (120). The controller (120) can send the time and location of the next event on each attendee's schedule to the portable device (100) used by that attendee. The device (100) notifies the attendee of the next event, its time and location, and may display a suggested path to get there on an interactive map of the trade show.

It may frequently be the case that a group of individuals attend a trade show together and wish to keep track of each other during the show. The present invention can provide additional features which facilitate the attendance of a group at a trade show. For example, when the location feature described above is operating, it can be used to illustrate the location of each member of the group for each member of the group.

Specifically, the location of each attendee is determined and provided to the controller (120). The controller (120) has been programmed to recognize certain attendees as part of a group. This may be done by registering the group together or by specifying the members of the group through, for example, the web host (130). The controller (120) transmits to the portable device (100) of each member of the group the current location of every other member of the group. The portable device (100) can then display a map of the trade show illustrating its own location as well as that of other members of the group to which the attendee belongs. On the interactive map, all persons that are tracked may appear as icons as they move through the coverage area. Area alarms can be defined that alert users when the persons they are tracking enter into regions of the coverage area that are not desirable.

To further facilitate coordination of a group at a trade show, a system according to the present invention may also have a messaging capability that allows messages to be sent from one portable device to another device, from a device to the controller, or from the controller to any or all portable devices. Each portable device (100) may include a number of standard or “canned” messages that can be selected and sent. These messages may be text, graphic, audio or video messages. The attendee can send the message to the portable device of another designated attendee. Alternatively, the attendee can send the message to the controller (120), perhaps with an e-mail address attached such that the message is sent via e-mail through the web host (130) to the designated address. The system may maintain a selection list with the most frequently used messages.

Alternatively, the portable device (100), as will be described in more detail below, may include a user input device that can be used to create a custom message to send. Depending on the type of message, it is either displayed at the destination or used as parameters into a program function, for example, to request some type of information or service, or to make a purchase as mentioned above.

Additionally, instead of one-way message service, a two-way voice link can be established between two portable devices (e.g., 100) under the principles of the present invention. Each portable device (100) may have a microphone into which the attendee can speak and a speaker for playing voice data received from another attendee. When an attendee speaks into the microphone of a portable device (100), the voice is recorded and digitized. The voice data is then packetized for transmission over the wireless infrastructure (101-120) to a designated recipient.

If both devices (e.g., 100) are in communication with the same base (e.g., 101), the voice packets may be relayed from the first device, through the base, to the second device. For devices that are in communication with different bases, voice packets are passed from one base to the next until the base with the recipient device is reached. Since voice packets will be going from base to base in both directions, some knowledge of the path taken can be used to keep down system overhead. For example, referring to FIG. 1, if the voice packets are sent from base (101), through base (102), and then to base (103), base (106) need not retransmit the packets that it receives from base (101). The best paths are periodically updated to reflect changes in device location or system characteristics.

Alternatively, the voice packets could be routed through the system controller (120). Each packet would take its shortest path to the controller (120), then the shortest path to the desired base before proceeding to the recipient portable device. This implementation may not provide the most efficient packet routing, but requires the least amount of overhead, since each portable device only worries about routing packets to the controller (120).

As mentioned above, purchasing software within the system of the present invention can be used to make transactions simpler by eliminating the exchange of cash or a credit or debit card. Rather, the transaction is completed electronically. Software in the portable device (100) may interface with the point-of-sale system (125) directly or through the controller (120). Merchandise or services can be searched, and descriptions of items or services, video samples, and availability can be viewed using the portable device (100). The point-of-sale equipment (125) preferably transmits this information to the portable device (100) via the wireless infrastructure (101-120) as requested by the portable device (100)

When a purchase is ordered, the total amount of the purchase is preferably tallied and transmitted to the portable device (100) for final customer approval. Approval can be entered to the portable device (100) and transmitted to the controller (120) and/or the point-of-sale equipment (125). Once approved, the controller (120) may look to see if a credit or debit account has been set up locally, e.g., the attendee has deposited funds with the system to be applied against such purchases made during the trade show. If there is no local account, the controller (120) can connect (132) to outside account management systems (135) e.g., a bank for a debit account, or a creditor for a credit account, to get approval for the transaction. Once the controller (120) gets approval of the transaction, the sale will be completed.

The portable devices (100) are also capable of displaying any type of advertisement that is sent to it by the controller (120). The controller (120) may select advertisements to send to a particular attendee based upon demographic data gathered with regard to that attendee, such as past interests expressed by customer actions, or past purchases made by the customer. Advertisements provide an opportunity for the customer to purchase the advertised product by simply pressing a button. The product can either be picked up at a location within the coverage area, or the product could be sent to the customer's address on file.

FIG. 2 illustrates a preferred embodiment of a portable device (100) according to the principles of the present invention. Portable device (100) can be embodied in a handheld or palm-size personal computer similar to Personal Digital Assistants (PDA's) that are in common use today. Portable device (100) may be implemented as a stand-alone device, or as a part of another device that is carried by the user. An alternative embodiment is a smaller device that may be worn on a wrist like a watch, carried in a pocket, or used as a key chain. If worn like a watch, popular watch functionality may be added to make the device more familiar to the user. The system may be deployed with any combination of these embodiments for portable device (100).

All functions of the portable device (100) are defined and executed by a controller (201). Memory (205), consisting of a mixture of volatile and nonvolatile storage, holds the executable program, configuration information, and temporary data. The controller (201) controls the state and information passed through the wireless interface (220). This wireless interface (220) is a transceiver, preferably a radio frequency transceiver, that is used to communicate with the system's base stations (e.g., 101 to 106; FIG. 1) and through them to the system controller (120; FIG. 1).

Customers interact with the portable device (100) and its controller (201) through a user interface that may include, for example, a display device (202), and a data entry device (203). The data entry device (203) can be, for example, a keypad, a trackball, a touch pad, or a touch-screen, perhaps incorporated with the display (202). Correspondingly, data entry through the data entry device (203) can be keystrokes on selected keys, manipulations of a trackball or touch pad, or taps on a touch screen. It is also possible that data entry from a user can be through voice commands passed through microphone (208) to a voice recognition module in the audio processing block (206).

As mentioned above, the portable device (100) may also be capable of sending and receiving audio messages or maintaining a continuous audio link. If this is the case, audio processing is done in the audio processing module (206), interfacing to a speaker (207) and microphone (208).

The user speaks into the microphone (208) which transduces the speech into an electronic signal that is then passed to the audio processing block (206). The audio processing block (206) preferably digitizes and packetizes the speech for transmission over the wireless interface (220) to the supporting wireless infrastructure. The data entry device (203) can be used to specify a designated recipient to which the voice packets will be sent. As in other wireless communication systems, addressing may be added to the headers of the voice packets for routing by the supporting system. Alternate audio processing includes voice command processing and feedback and alert tones.

When voice packets are received through the wireless interface (220) from another sender, those voice data packets are routed to the audio processing block (206) which converts the packets into an analog audio signal that can be sent to the speaker (207) for reproduction as audible sound. In this way, two-way voice communication can be provided between two portable devices (e.g., 100) on the system as described above.

Power for the portable device (100) is stored by a power storage device (210), preferably a battery of the latest technology. When connected to an external power source through the connector (215), a charger (211) can preferably recharge the power storage device (210).

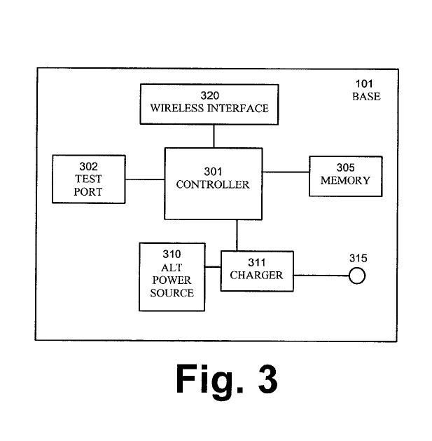

FIG. 3 illustrates a preferred embodiment for a wireless base station (e.g., 101-106; FIG. 1) as used in the supporting wireless infrastructure for a system according to the principles of the present invention. The architecture is similar to the architecture of the portable device (100), absent the user interface and audio processing block.

The controller (301) controls the state of the base (101) and the data or messages that are transmitted. The memory unit (305) is a combination of volatile and nonvolatile storage that holds the executable program, configuration information, and temporary data. The wireless interface (320) is preferably a radio frequency transceiver that is used to wirelessly send messages and data to the portable devices (100; FIG. 1), to the controller (120; FIG. 1), to other bases (e.g., 102-106; FIG. 1) and to other components of the system, such as point-of-sale equipment (125; FIG. 1), data exchange boxes (150, 151; FIG. 1), kiosks (e.g., 141; FIG. 1), etc.

Because the base (100) is stationary, power can be primarily provided to the base (101) through a connector (315) that connects it, for example, to a wall outlet, a light socket, or other power source. However, an optional, alternate power source (310) can be used to supplement external power. The alternate power storage (310) can be a rechargeable temporary storage, or can be a power-generating device that uses solar, wind, or water energy to generate power for the base (100). The alternate power source may be any combination of those described. In the case of a rechargeable storage device, a charger (311) can be provided to recharge the alternate power source (310) when external power is available through the connector (315). Additionally, the base (101) may have an additional connection, for a wired network connection, for connecting an Ethernet or other physical network connection to communicate back to the controller (120).

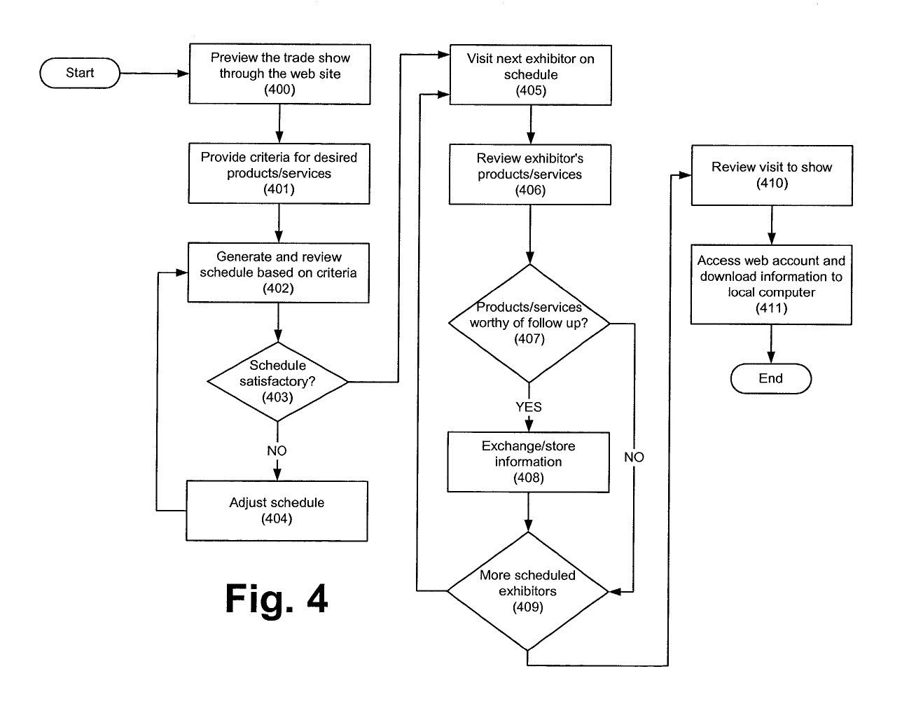

FIG. 4 is a flowchart illustrating one possible method of using a system according to the present invention. As shown in FIG. 4, the prospective trade show attendee can preview the trade show (400) at a web site supported by, for example, the web host ( 130; FIG. 1). The preview will preferably provide a list of all exhibitors and, perhaps, additional information about the products or services of each.

The web site may also ask the attendee to enter criteria (401) defining products or services the attendee needs or desires to locate through the trade show. The web site then sorts the exhibitors (402) according to the attendee's criteria and suggests exhibitors the attendee will likely want to visit. The web site can also organize these suggestions in to a schedule (402). The schedule may organize exhibitors according to location at the trade show or in order of relevance to the attendee's criteria.

The attendee can review the schedule offered by the web site and determine if it is satisfactory (403). If it is not, the web site will allow the attendee to make adjustments to the schedule (404), for example, by adding to, deleting from or rearranging the exhibitors listed. When the schedule is satisfactory (403), the attendee is ready to attend the trade show and maximize the use of his or her time while there.

Upon arrival at the trade show, the attendee obtains a portable device into which the schedule created by the attendee has been loaded. Alternatively, if the attendee already owns a portable device that is compatible with the wireless system in the trade show venue, the attendee can download the application into his portable device from the website and begin using the device upon entering the wireless coverage area. If the attendee has not visited the web site previously and created a schedule, the attendee may do so upon arrival at the show. For example, a dedicated terminal connected to the web host (130; FIG. 1) or the system controller (120: FIG. 1) may be provided to allow an attendee to create a schedule of exhibitors and seminars to visit.

The scheduled attendee then visits the first and next exhibitor on the schedule (405). As described above, the portable device may provide the attendee with reminders of the exhibitors to visit, the time allotted to spend at a particular exhibit, and/or directions, textual or graphic, to the next scheduled exhibitor.

The attendee can review the products or services of the exhibitor being visited (406) and determine whether additional information is wanted or whether a purchase should be made on the spot. If a purchase is to be made, the attendee may make a purchase order using the portable device, as described above, and complete the transaction electronically. If more information is desired, the attendee can interface with the data exchange box (150: FIG. 1) for that exhibitor and download additional information to the attendee's portable device and/or direct additional information (408) to that attendee's account on the web host (130; FIG. 1). The attendee can also upload his or her contact information so that the exhibitor can further contact the attendee (408).

The attendee then moves on to the next scheduled exhibitor, if any more exhibitors remain on the schedule (409). When the show is over and all scheduled exhibitors have been visited, the attendee can review information gathered during the visit to the trade show (410). This can be done be reviewing information loaded to the portable device and/or accessing the attendee's account on the web host (130; FIG. 1) and downloading the information stored there to a local computer (411).

In this way, the time the attendee spends at the trade show can be used as efficiently as possible. The attendee need visit only those exhibitors who are likely to service the attendee's needs. The attendee can readily obtain information from exhibitors of interest and provide those exhibitors with contact information for the attendee. Thus, the time spent at the trade show is made more profitable. The system increases the efficiency of a trade show attendance, requiring an attendee to spend less time at the show while still getting the same information and contact networking.

With this system in place, an attendee of a particular show can access the system before the trade show; find basic information about the show and the exhibitors; electronically register for the show; gain access to additional exhibitor information; specify priorities and goals of the attendance; plan for the attendance, including travel arrangements; use a handheld device to gain access to the show floor; navigate the floor with the help of the handheld device; transfer information, including contact or product/service information, while on the show floor; coordinate locations/schedules with others attending the show; receive any show change information; make electronic purchases from the floor; plan/change travel arrangements; keep in contact with the outside world while on the floor; review the attendance after the show; review information gathered while at the show; generate expense reports; update contact lists; and automatically follow-up with contacts.

Consider the following example of how the system can be used to benefit an attendee that is looking to find and later purchase the best widget in a trade show located far from his office. After learning about the show, the attendee views some preliminary information about the show on the show's website. This information may include such details as the location of the show, attendance costs, exhibitor list, review of the type of products that will be displayed, and photos from the previous show.

After making the decision to attend, the attendee can electronically register for the show and use the website to complete travel arrangements. After registering, the attendee enters his priorities for the trip, including the exhibitors that are most important to see; the time allocated to the show floor, seminars, and follow-up meetings; and the specifications of the desired widget that are most important.

The system controller then returns a suggested schedule, including exhibitor meeting times, seminars to attend, and a path to follow on the show floor. The attendee downloads this information, as well as a custom application, into his wireless PDA or is provided with a wireless portable device upon arrival at the show.

Before attending, the attendee reviews the plans for the visit on his PDA, adding and removing exhibitors from his schedule, changing seminar attendance, scheduling meeting times with other attendees, making meal plans/reservations, and fine-tuning the desired specs of the widget.

Once on the trade show floor, the portable device highlights the location of the attendee on a map, and highlights the path to the next appointment. The attendee can view information about exhibitors, facilities, and the surrounding area on the portable device. So as he proceeds to his first planned stop, he sees an attractive booth, selects that booth on the map on the portable device, and views the provided information about that exhibitor. Their widgets are not exactly what he is looking for, but with a selection he adds that exhibitor to the schedule for the day. The portable device then reports that he has an appointment with that exhibitor set for later that afternoon.

While the attendee walks towards the first scheduled booth, he sees on his portable device that another attendee of his group has entered the trade show floor. He sends a message to this attendee, asking to meet for lunch. A lunchtime and meeting place are selected by the system, and exhibitor meetings are dynamically rescheduled accordingly.

After visiting the first scheduled booth, the portable device highlights the route to the next appointment. En route, the attendee sees another interesting booth, selects it on the portable device to find more information, and decides to store the information about this company in his web account that is maintained by the system for later Internet access by the attendee.

At the second scheduled appointment, the initial meeting goes well, and the attendee feels comfortable talking to the sales representative at that booth. He elects to forward his contact information to this company by using his portable device. In return, he receives from the company in his web account an expanded set of product information regarding the particular widget that he is looking for. Also, inspired by the conversation, the company forwards a custom quote for the widgets that appear as a high-priority item in the attendee's web account.

As he moves towards the next scheduled appointment, the attendee wants to find a drink. He pulls up the drink menu on the portable device, and electronically purchases a soft drink. The cost is debited from the attendee's account as described above. The map on the portable device highlights the path to the place to pick up the drink, and his next appointment is automatically adjusted to allow time to pick up the drink. At the drink stand, he uses his portable device as proof of the soft drink purchase, picks up his drink, and is on his way.

Surprised at how well the day is going, he decides to cancel his dinner reservations at the hotel restaurant and find one of the more popular restaurants in the area. Using his portable device, he may access a list of local restaurants, select one that offers a coupon through the trade show he is attending, and make reservations for later that evening. The system transmits the reservation request to participating restaurant.

The attendee then receives an email through his work email account marked as a high priority. He takes a few minutes to pull a spreadsheet from his electronic public storage area, change some numbers, and forward the results through email to the requestor. In the mean time, the system moves back his next appointment five minutes so that the attendee does not have to run across the trade show floor to get there in time.

He continues this way through the day, meeting exhibitors and other attendees throughout the day. Contacts and information on widgets are gathered for later review. The visit to the show is ended, and the attendee proceeds to return to the office.

On the return trip, the attendee reviews the ground covered on the trade show floor by pulling up a travel history on the portable device. This highlights his travel path and indicates the booths that he stopped at, with a different indicator for the booths worth following up with. He then reviews the information that was gathered from each of the booths, which are stored electronically. Some of the information was put into his storage area based upon the initial criteria he entered before the trip. Also stored is the contact info of the contacts that are worth following up.

When he returns to his office, the attendee logs into the web page of the trade show and reviews the information gathered at the show. This web account holds all of the brochures, catalogs, and business cards collected at the show. This information may be sorted on priority, so the information that most closely matches his initial criteria, and the information that was marked as important remains at the top of the list, and the most easily accessible. Information is stored with appropriate header data that shows the company contact info, sales person contact info, and any collected notes along with the actual product or company brochures. This allows the attendee to instantly send email to the sales person while reviewing the information. The attendee then copies the most important information over to his computer for future reference.

This example captures one implementation of the trade show solution offered by the principles of the present invention. If the attendee in this example did not have a wireless portable unit, but did have a PDA he wanted to use in conjunction with this system, he can follow a different path with the same net result. Consider the attendee downloading the custom application and using it similarly to the above example. The difference would be the wireless connectivity on the trade show floor. Without wireless connectivity, the PDA would not be able to report the position of the attendee on the floor.

To exchange information and keep information in the PDA up to date, there would be locations on the floor to ‘synchronize’ the data in the PDA with the data on the server. This may be in the form of the kiosks described in connection with FIG. 1 with an infrared or a cabled connection to the PDA. Once connected, any information updates would take place, including contact, exhibitor, or facility changes. So the attendee who was planning on meeting a sales representative could find out that that representative was not able to meet that day, and the attendee's schedule was automatically adjusted to meet the next day. Attendee schedules, seminar information, food menus, surrounding hotels and restaurants, etc. could be updated each time the attendee synchronizes with the server.

In this scenario, the attendee can exchange information with sales people at a particular booth via infrared or cable instead of a wireless RF connection. Information and contact exchange would be identical to the exchange that took place in the wireless example. In some instances, this implementation may be preferred, as it offers inherent security, requiring users to interact with a station located within each booth.

The kiosks and the booth connection can connect back to the server either by a wired network connection or a wireless connection. The wireless connection allows for more flexibility in the location of the devices, and allows for more devices to be deployed without additional installation costs.

There are also examples for the attendee that does not own a PDA. The simplest implementation is for the trade show organizers to provide a portable device to the attendee, either included as part of the attendance fees, or for a small rental cost. Functionality would then be the same as the attendee that brings his own wireless PDA.

Alternatively, the attendee could prepare for his attendance on the website and print out a travel plan and a schedule to be implemented at the show. For updates, he can login into the kiosks and either copy the changes or print out a new itinerary from the kiosk. A magnetic card, wristband, or barcode could be used for identification at each of the booths so that information is exchanged.

In either non-PDA implementation, the attendee receives information in his web account, and can review this information from the website after the trade show is over.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A method for attending a trade show at a trade show venue, said method comprising carrying a wireless portable device with a user interface while attending said trade show, and, with said portable device, receiving information about said trade show from a wireless infrastructure that provides a wireless service area encompassing some or all of said trade show venue.

2. The method of claim 1, further comprising displaying a map of said trade show on said portable device.

3. The method of claim 2, further comprising displaying a current location of said portable device on said map.

4. The method of claim 2, further comprising displaying a current location of one or more other trade show attendees on said map.

5. The method of claim 1, further comprising receiving a message with said portable device.

6. The method of claim 1, further comprising sending a message with said portable device.

7. The method of claim 1, further comprising, using said portable device, conducting a two-way voice communication with another trade show attendee who is also using a portable device.

8. The method of claim 1, further comprising tracking a schedule of exhibitors, seminars, or events to be visited at said trade show with said portable device.

9. The method of claim 8, further comprising logging onto a trade show website prior to attending said trade show to generate said schedule of exhibitors or seminars.

10. The method of claim 9, wherein said generation of said schedule further comprises:
entering criteria to said website defining products, services, technologies, themes or exhibitors of interest to a user; and
generating said schedule based on said criteria.

11. The method of claim 1, further comprising, with said portable device, storing collected information about products, services or exhibitors at said trade show.

12. The method of claim 11, wherein said storing collected information further comprises directing said information to a web account of a user that is accessible via the Internet, said method further comprising accessing said web account via the Internet to access said information.

13. The method of 1, further comprising making a purchase by entering a purchase order into said portable device.

14. The method of claim 1, further comprising providing contact information to an exhibitor at said trade show with said portable device.

15. The method of claim 14, further comprising electronically downloading said contact information from said portable device to a data exchange box associated with said exhibitor.

16. The method of claim 1, further comprising receiving advertisements with said portable device.

17. The method of claim 1, wherein said wireless infrastructure is connected to the Internet and said method further comprises receiving an e-mail message transmitted via the Internet with said portable device.

18. The method of claim 1, wherein said wireless infrastructure is connected to the Internet and said method further comprises using said portable device to access information about local businesses, wherein said portable device can be used to make reservations or purchases within said businesses.

19. A trade show venue comprising:
spaces for exhibitors within said trade show venue;
a network of wireless base stations that provide a wireless communication service area within said trade show venue; and
a controller configured to communicate with said network of wireless base stations to provide data to wireless portable device in said service area used by trade show attendees.

20. A method of conducting a trade show at a trade show venue, said method comprising:
providing attendees with a wireless portable device with a user interface to be carried while attending said trade show; and
transmitting receiving information about said trade show to said portable devices from a wireless infrastructure that provides a wireless service area encompassing some or all of said trade show venue.

21. A method of soliciting attendance at a trade show, said method comprising:
providing an access to information about said trade show;
receiving criteria that defines a product, service or exhibitor that a prospective attendee of said trade show desires; and
automatically generating a schedule for attending said trade show for said prospective attendee based on said criteria.

22. The method of claim 21, further comprising accepting registration for said trade show through said website.

23. The method of claim 21, further comprising downloading said schedule into a personal digital assistant for use at said trade show.

24. The method of claim 21, further comprising printing said schedule for use at said trade show.

25. The method of claim 23, further comprising providing at least one kiosk at said trade show at which an attendee can update or make changes to said schedule.

26. The method of claim 24, further comprising providing at least one kiosk at said trade show at which an attendee can update or make changes to said schedule.

27. The method of claim 23, further comprising providing at least one kiosk at said trade show at which an attendee can transmit contact information to a designated exhibitor or receive and store information from a particular exhibitor.

28. The method of claim 24, further comprising providing at least one kiosk at said trade show at which an attendee can transmit contact information to a designated exhibitor or receive and store information from a particular exhibitor.

29. The method of claim 23, further comprising providing at least one kiosk at said trade show at which an attendee can access travel planning functions or local businesses for reservations or purchases.

30. The method of claim 24, further comprising providing at least one kiosk at said trade show at which an attendee can access travel planning functions or local businesses for reservations or purchases.
